(19) United States
(12) Patent Application Publication
(10) Pub. No.: US 2006/0096177 A1
(43) Pub. Date: May 11, 2006

(54) Drive for a sliding door or a swinging-sliding door

(76) Inventor: Alfred Schneckenleitner, Waidhofen/Ybbs (AT)

Correspondence Address: BARNES & THORNBURG, 750-17TH STREET NW, SUITE 900, WASHINGTON, DC, 20006-4675, US

(21) Appl. No.: 10/522,122

(22) PCT Filed: Jul. 24, 2003
(86) PCT No.: PCT/EP03/08117

§ 371 Date: Aug. 15, 2005

(30) Foreign Application Priority Data
Jul. 25, 2002 (AT) A 1133/2002

(51) Int. Cl. E05F 11/40

(52) U.S. Cl. 49/362

(57) ABSTRACT

The drive for a sliding door or a swinging-sliding door of a rail vehicle, comprising a guide rail which is fixed inside the rail vehicle and on which a carriage carrying a door leave is arranged in a longitudinally displaceable and optionally rotatable manner, and a spindle drive provided with a spindle which extends parallel to the guide rail and a spindle nut which is connected to the carriage in a fixed manner in the direction of the axis of the spindle. The spindle nut and the carriage are connected by means of a rotative sliding joint.

The invention relates to the drive of a sliding door or swinging-sliding door of a rail vehicle, having a guide rail fixed with respect to the rail vehicle, on which guide rail a carriage is longitudinally displaceably and optionally rotatably arranged, which carriage carries a door leaf, and having a spindle drive whose spindle extends parallel to the guide rail and whose spindle nut is fixedly connected with the carriage in the direction of the axis of the spindle.

Different constructions of swinging-sliding doors exist which implement the tilt-out and sliding movement of the door leaf in different manners and in the process also establish the connection between the actual drive and the door leaf in different manners.

In a construction which has been known for some time and has been successful, the door leaf hangs on a carriage which itself is displaceable along a circular guide rail fixed to the body. The carriage can also be swiveled about the guide rail, and the door leaf is also linked to the carriage and is swivellable parallel to the axis of the guide rail, whereby the tilt-out movement of the door leaf is ensured. The drive takes place by way of a driving spindle rotatable about itself and fixed to the body and by way of a spindle nut running on the spindle. The connection between the spindle nut and the carriage takes place by way of a connecting rod which can be swiveled on the spindle nut as well as on the carriage in each case about an axis parallel to the axis of the guide rail.

This construction has essentially been successful and, as mentioned above, has been used for some time but still has certain disadvantages: The connecting rod, by which the moving forces for the door leaf are transmitted in the direction of the axis of the guide rail, is stressed with respect to bending and shear by these considerable forces. These forces have to be transmitted by the two hinge joints, which requires that they be constructed in a correspondingly massive and therefore heavy and expensive manner. As a result of the relatively large distance of the connecting rod or its hinge joints with respect to the axis of the guide rail, on the one side, and with respect to the axis of the spindle, on the other side, the carriage as well as the spindle nut are stressed during the operation on their seats with respect to tilting, which, in the case of the carriage, results in an increased edge pressure and, in the case of the spindle nut, results in a one-sided loading of the thread. In addition to all of the above, sufficient space has to be left for the sliding-past of the connecting rod over the entire moving path of the carriage.

Also in the case of pure sliding doors having the initially defined basic construction, it is necessary, for the compensation of tolerances, wear phenomena, different thermal expansions and the like, to use a construction having a connecting rod, which causes the same problems as in the case of swinging-sliding doors.

It is an object of the invention to avoid the above-mentioned disadvantages and provide a construction which requires less space, has a dynamically and statically more favorable flow of force and is also cost-effective in its production.

According to the invention, these objects are achieved in that the spindle nut has a radial projection which rotatably and longitudinally displaceably, therefore by means of a sliding hinge joint, interacts with a seat of the carriage.

In this manner, it is achieved that the connecting rod can be completely eliminated and that, instead of the two hinge joints, a single hinge joint combined with a displacing seat is provided, which is situated essentially in the area of the direct connection between the axes of the guide rail and the spindle. In this manner, the above-mentioned disadvantages of the force transmission by the unfavorable eccentric arrangement are completely avoided, and the displacing seat is preferably constructed by a claw-type construction of the radial projection on a relative large surface, so that the surface pressure can be minimized.

Furthermore, this construction permits the axial adjusting of the door leaf by inserting or removing shims and thus eliminating the previously necessary adjustment by means of expensive threaded bolts.

In the following, the invention will be explained in detail by means of the drawing.

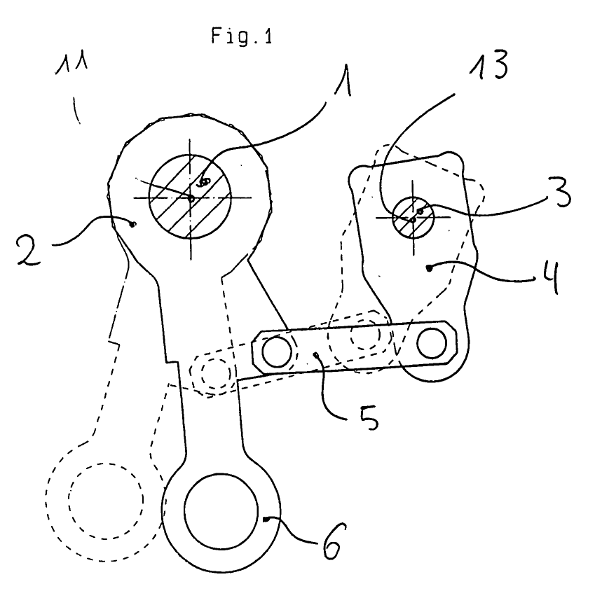

FIG. 1 is a view of a drive coupling according to the prior art;

FIG. 2 is a view of a device according to the invention in the swiveled-in positions of the door leaf;

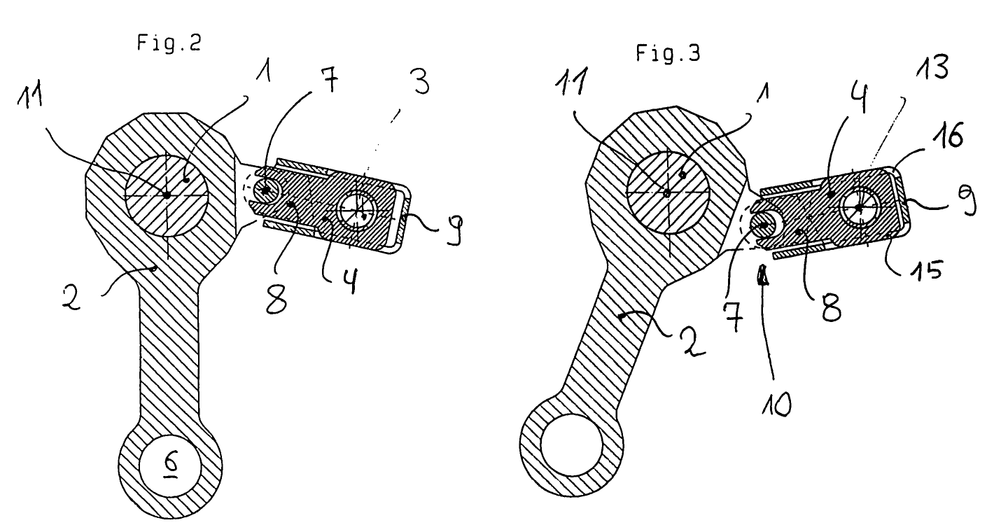

FIG. 3 is a view of the device of FIG. 2 in the swiveled-out position of the door leaf; and

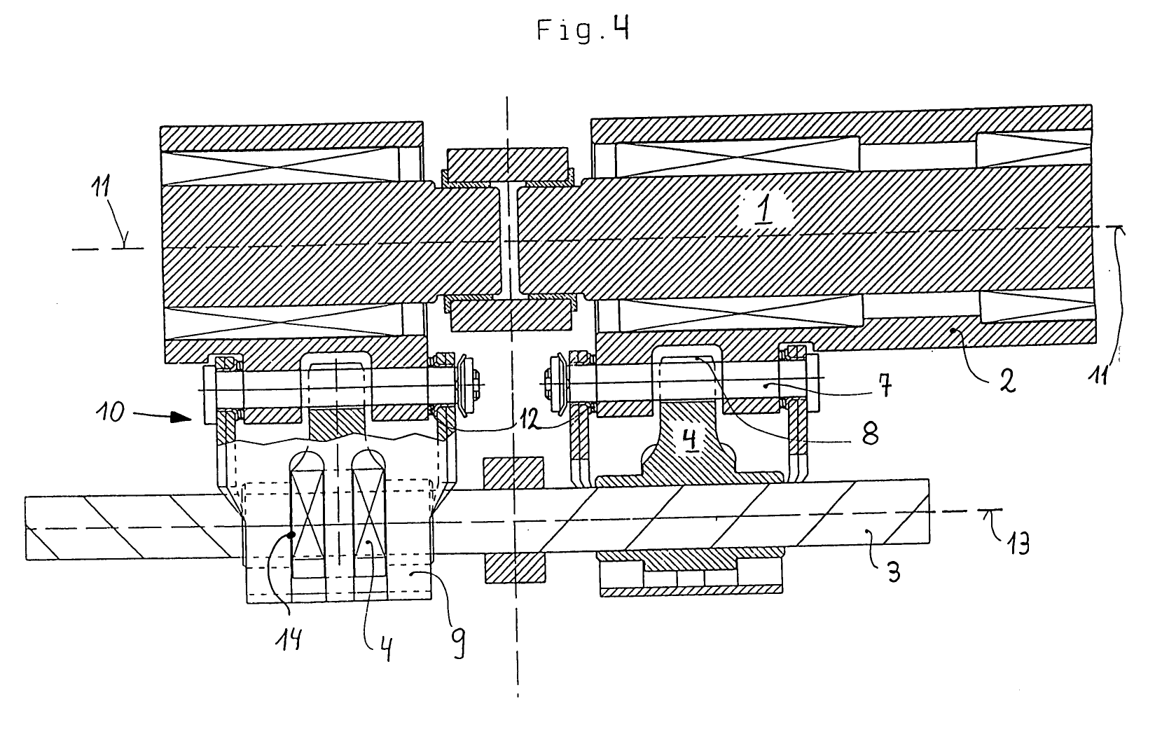

FIG. 4 is a sectional view which extends essentially through the axes of the guide rail and of the spindle.

Of a door drive according to the prior art, FIG. 1 shows the parts essential to the invention, specifically a guide rail 1 fixedly mounted to the body, a carriage 2, a rotatable but otherwise body-fixed spindle 3, a spindle nut 4 and a connecting rod 5 connecting the carriage 2 with the spindle nut 4.

The carriage 2 is arranged to be longitudinally displaceable along the guide rail 1 and, as outlined by the position illustrated by a broken line, in a swivellable manner. At the lower end of the carriage 2, the mounting possibility for a door leaf, which is not shown, is schematically indicated by an eye 6. The longitudinal movement of the carriage 2 along the guide rail 1 is caused by the spindle nut 4 which is moved along the spindle by the rotation of the spindle 3 by means of a drive which is not shown.

By means of a hinge joint, the connecting rod 5 is in each case connected with a radial projection of the spindle nut 4 and a bearing part of the carriage 2 and thus, when moved along the spindle 3, takes along the carriage 2 and thus the door leaf in the direction of the axis 11 of the guide rail 1.

The tilt-out movement of the door leaf can be caused in different manners. It conventionally takes place by means of a guide rail, which is not shown, is fastened to the body and into which a projection of the door leaf or of the carriage engages, appropriately by means of a roller. As illustrated in FIG. 1, during the tilt-out movement—which corresponds to the transition from the solid lines to the broken lines—, the spindle nut 4 is also swiveled because it is taken along by way of the connecting rod 5 in the manner of a four-bar mechanism, in which the connecting rod 5 is to be considered as a coupling device, and the axis 11 and the axis of the spindle 3 are to be considered as base points.

The drawing illustrates that the longitudinal forces (in the direction of the axes 11, 13) during the displacement of the door leaf have to be transmitted from the thread of the spindle 3 to the hinge joint between the spindle nut 4 and the connecting rod 5, whereby the spindle nut 4 is caused to tilt with respect to the spindle 3, which results in a non-uniform stressing of the thread. Completely analogously, the carriage 2 is stressed by a tilting moment and thus caused to tilt also with respect to the guide rail 1 by the driving forces transmitted by the hinge joint between the connecting rod 5 and the carriage 2, which causes an increased edge pressure at the edge of the guide of the carriage 2. Finally, by means of the forces acting upon the connecting rod 5, which occur in a normal manner with respect to the paper plane of FIG. 1, the connecting rod 5 is stressed with respect to bending as well as shear and therefore should have a correspondingly massive construction.

These problems are solved according to the invention as illustrated in FIGS. 2 and 3: In the specification, the parts which are identical with those of FIG. 1 have the same name and are provided with identical reference numbers. Naturally it is conceivable that these parts may have different constructions or further developments.

An important difference with respect to the solution of the prior art consists of the fact that the spindle nut 4 has a radial projection 8 which, as illustrated, preferably is oriented essentially toward the guide rail, and that this projection 8 interacts with an abutment 7 of the carriage 2. According to the invention, this interaction takes place such that a rotation of the projection 8 about the abutment 7 can take place as well as a displacement, which essentially takes place in the radial direction with respect to the axis 13 of the spindle 3. In the illustrated embodiment, a cover 9 is used for this purpose, which will be explained in detail in the following.

The cohesion of FIGS. 2 and 3 directly indicates the method of operation of the construction according to the invention: When the carriage 2 is swiveled about the guide rail 1, the abutment 7 describes a circular swiveling movement about the axis 11 of the guide rail 1 and, in the process, takes along the projection 8 of the spindle nut 4—in the illustrated example, in the manner of a mangle gear. The change of the distance between the abutment 7 and the spindle axis 13 is compensated in that the projection 8 reaches around the abutment 7 in a claw-like manner and thus allows or compensates not only the change of the angular position but also the change of distance.

FIG. 4 is a sectional view of a two-leaf door, which has a different construction in the two drives in order to clearly show the design. The sectional view extends essentially through the axis 11 of the guide rail 1 and the axis 13 of the spindle 3 and thus shows the situation and particularly the force transmission in the direction of the two axes 11, 13: The two spindle nuts 4 have a noticeable axial dimension in order to be able to transmit the necessary forces or moments by way of a corresponding number of turns of the spindle thread. At the free ends of their radial projections 8, they have a claw-like or comb-like or pronged construction, as particularly illustrated in FIGS. 2 and 3, where the upper and lower prongs of the claw reach around the bolt-shaped abutment 7 with little play.

As illustrated in FIG. 4, the abutment 7 is constructed in the form of a bolt which is guided through corresponding recesses of a projection of the carriage 2 and is axially and radially fixed in the carriage 2.

The role of the cover 9 is the transmission of the axial forces to the spindle nut 4 as well as to the carriage 2: For this purpose, contact surfaces 14 are provided between the spindle nut 4 and the cover 9, which contact surfaces 14 are displaceable with respect to one another in the direction between the abutment 7 and the axis 13. The projection 8 provides that, despite a certain polydirectional play between the nut 4 and the cover 9, this orientation is maintained. By means of its lateral (in the axial direction) ends 10, the cover 9 is fixedly (or rotatably) connected with the abutment 7 which, in turn, is rotatably (or fixedly) mounted in the carriage 2. In this case, intermediate disks or shims 12 are provided by means of which an adjusting can easily be carried out in the axial direction. The force transmission takes place by way of these shims.

It is naturally not necessary to provide such a massive construction, particularly if, within the scope of a sliding door, the basic idea of the invention is used only for compensating tolerances and for an easier adjustability. The guide of the cover can be provided directly on corresponding surfaces of the nut, without the nut reaching around the abutment. It is essential that the nut-cover entity has a rotatable and displaceable construction with respect to the abutment.

Also in a heavy-duty application, the above-illustrated massive construction permits the use of plastic for the nut 4, which is desirable for various reasons and ensures an extremely long service life also when operated under harsh conditions.

As also illustrated in FIG. 4, this embodiment permits a simple and cost-effective adjusting between the carriage 2 and therefore the door leaf, on the one hand, and the spindle nut 4, on the other hand, if specifically the axial dimensions between the ends 10 of the cover 9 and the individual sections of the carriage 2 in the area of the abutment 7 are coordinated such that, as a result of the sliding-in of shims 12, the axial position between these two part is determined. Then, by simply exchanging or inserting/removing shims, a precise axial adjusting can take place in an area of a few millimeters in a simple rapid and inexpensive manner.

The invention is not limited to the illustrated embodiment but can be modified in various manners. Thus, it is not necessary that the abutment 7 is essentially arranged in the area of the connection plane between the axes 11 and 13. The abutment 7 could also be arranged in the area in which the hinge joint is situated between the connecting rod 5 and the carriage 1 in FIG. 1. However, it is a disadvantage of each embodiment which provides such an eccentric linkage that high tilting moments are again (as in the prior art) exercised at least on the carriage 2; that the space requirement for the device is enlarged; and that the displacement path in the bearing is enlarged. That, in addition, also greater bending moments occur and the arrangement requires a heavier and more massive construction not only because of the larger dimension but also because of these greater moments, is only marginally mentioned here.

Furthermore, it is not necessary that the prongs of the claws are constructed as illustrated on their front side. It is also conceivable to construct them as an oblong hole, which then makes it absolutely necessary to be able to install or remove the abutment 7 in the axial direction, for example, by means of the bolt 7, as in the present embodiment. On the other hand, it is not necessary to construct this abutment 7 as a bolt. Since the transmission of the swiveling is not connected with very large forces, it is definitely conceivable to provide for this transmission of the rotating movement only a type of driver in the form of a projection or mandrel.

If sufficient space exists in the area of the carriage, or very little space is available in the area of the spindle nut, it is also conceivable to turn the arrangement around and to mount the abutment on the spindle nut. However, this turning-around should be preferred over the illustrated arrangement only in special cases, which is why it is not explained in detail in the specification.

The cover 9 preferably consists of a piece of sheet metal and is bent around the spindle nut 4. In this case, the spindle nut 4 has ribs 15 in planes normal with respect to the axis 13, which ribs 15 protrude into openings 16 of the cover 9 (FIG. 3). Thus, while the play between the nut and the cover is small on all sides, a precise guidance and an unproblematic transmission of forces is achieved.

It is always only essential for the invention that the connection between the spindle nut 4 and the carriage 2—these components also include all components fixedly connected with them during the intended operation—takes place by a joint which permits a relative rotating movement between these two components as well as a displacing movement between these two components in the joint area. In the specification and the claims, such a joint is called a sliding hinge joint.

1. A drive for a sliding door or swinging-sliding door of a rail vehicle comprising:
a guide rail fixed with respect to the rail vehicle;
a carriage longitudinally displaceably on the guide rail and carrying a door leaf;
a spindle drive including a spindle which extends parallel to the guide rail and a spindle nut which is fixedly connected with the carriage in the direction of the axis of the spindle; and
the connection between the spindle nut and the carriage includes a sliding hinge joint which permits a relative rotating movement as well as a displacing movement in the joint area.

2. The drive according to claim 1, wherein the spindle nut has radially projecting ends and interact with an abutment of the carriage.

3. The drive according to claim 2, wherein the abutment includes a bolt extending parallel to the guide rail.

4. The drive according to claims 1 wherein mutually facing surfaces of components of the sliding hinge joint, which extend perpendicular to the guide rail, have a distance from one another which is closed by shims.

5. The drive according to claim 1, wherein the sliding hinge joint includes the spindle nut and a cover which is slidable with respect to the spindle nut in a plane perpendicular to the axis of the spindle.

6. The drive according to claim 5, wherein ends of the cover have passage holes parallel to the axis of the spindle and a bolt extends through the passage holes and holes the carriage.

7. The drive according to claim 5, wherein the cover consists of a piece of sheet metal and is bent around the spindle nut.

8. The drive according to claim 7, wherein the spindle nut has ribs in planes perpendicular to the axis of the spindle, which ribs project into indentations or holes of the cover.

9. The drive according to claim 2, wherein the radially projecting ends of the nut are claw shaped.
